(19) United States
(12) Patent Application Publication
(10) Pub. No.: US 2002/0145279 A1
(43) Pub. Date: Oct. 10, 2002

(54) Add-on safety harness for school bus

(76) Inventor: Constance S. Murray, Palm City, FL (US)

Correspondence Address: Richard C. Litman, LITMAN LAW OFFICES, LTD., P.O. Box 15035, Arlington, VA, 22215, US

(21) Appl. No.: 10/106,208

(22) Filed: Mar. 27, 2002

Related U.S. Application Data
(60) Provisional application No. 60/281,376, filed on Apr. 5, 2001.

(51) Int. Cl. B60R 22/00

(52) U.S. Cl. 280/801.1

(57) ABSTRACT

An add-on safety harness for a school bus seat having a lap belt. An elongated anchor strap for attaching vertically around a seat back has an adjustable buckle. A first pair of shoulder straps extends at an acute angle from each side of the anchor strap, and ending in a loop. A second pair of leg straps with looped ends extends similarly from each side of the anchor strap. Each shoulder strap has an automatic roll-type adjuster device at a median position. A piece of synthetic lambs' wool is attached to each adjuster device for wrapping around the adjuster device, being fastened by hook and loop fastening material. The conventional seat belt on the, school bus is threaded through the loops of the shoulder and leg straps. The leg straps can be positioned inside the shoulder harness for small children and outside the shoulder harness for larger children.

### CROSS-REFERENCE TO RELATED APPLICATION

This application claims the benefit of U.S. Provisional Patent Application Serial No. 60/281,376, filed Apr. 5, 2001.

### BACKGROUND OF THE INVENTION

1. Field of the Invention

The present invention relates generally to vehicle safety belts. More specifically, the invention is a portable restraining belt adapted for use by children in conjunction with existing lap type safety belts in school buses.

2. Description of Related Art

The related art of interest describes various harnesses for vehicles, but none discloses the present invention. There is a need for a dependable, portable, removable student harness for a school bus. The related art will be discussed in the order of perceived relevance to the present invention.

U.S. Pat. No. 5,540,403 issued on Jul. 30, 1996, to Jeff W. Standley describes an airplane seat child safety harness comprising a pair of shoulder straps, each having an adjustment clip. The ends of the straps are sewn to an adjustable lap type securement strap. The child harness is attached to the mother passenger's seat belt and the baby sits on her lap. The harness is distinguishable for the requirement of being attached to another person and not to a passenger seat back.

U.S. Pat. No. 3,954,280 issued on May 4, 1976, to Verne L. Roberts et al. describes a child auto restraint harness having a rigid strap plate having an anchor strap secured thereto with the opposite end of the anchor strap secured to means for transferring impact energy to the frame of the vehicle. Two shoulder straps are also affixed to the strap plate. The anchor strap wraps around and attaches behind the car seat. The harness is distinguishable for requiring a rigid strap plate placed to contact the back of the child.

U.S. Pat. No. 4,205,670 issued on Jun. 3, 1980, to James R. Owens describes a child's restraining harness for use on school buses, vans, and other vehicles. The harness includes a pair of straps with a means for interconnecting the ends of the straps around the seat back. A number of aligned loops are formed on each strap. A waist belt and a chest belt each pass through a pair of aligned loops on the straps. The harness is distinguishable for requiring waist and chest belts without any

U.S. Pat. No.5,131,683 issued on Jul. 21, 1992, to Ellis D. Johnson describes a torso restraining assembly for an automobile seat having a Y-section in front with a pair of shoulder straps that extend over the back of the car seat and anchored separately on the floor. The front section has a loop on the leg of the Y-section for passing a seat belt through. The harness is distinguishable for requiring the anchoring of the harness on the floor behind the seat.

U.S. Pat. No. 5,624,135 issued on Apr. 29, 1997, to Barbara J. Symonds describes a portable seat belt attachable to a school bus bench seat comprising two loops encircling the back of the bench seat and joined near the seat by a belt with separate male tongues for combining with the buckles from the back encircling loops. In effect a combination lap belt and two shoulder belts. The seat belt is distinguishable for its requirement for a one-piece shoulder and lap belt.

U.S. Pat. No. 4,289,352 issued on Sep. 15, 1981, to Roger A. Ashworth describes a shoulder height adjuster for seat belt systems having shoulder belts comprising a 3-point safety system including a retractor on the floor behind the seat on the passenger's right side which feeds a belt through a guide on a wall and through a main connector, a seat belt connector, around the seat back, and back to the main connector. The seat and shoulder belt system is distinguishable for requiring floor anchorage and a double belt connector.

U.S. Pat. No. 4,488,691 issued on Dec. 18, 1984, to Daniel L. Lorch describes a harness for restraining the torso of a crewman in a seat aboard an aircraft. The harness has manifold belts which traverse both shoulders and both thighs. The harness is distinguishable for its required double shoulder and thigh elements.

U.S. Pat. No. 4,632,425 issued on Dec. 30, 1986, to Mary A. Barratt describes a passenger restraint system comprising a seat back envelope of heavy duty fabric overlying a seat back and extend below the seat back for anchoring. Additional webbing on the envelope is equipped with various closures. A garment is provided which includes fittings attachable to the envelope. A restraint vest is used in combination with the seat back envelope. The passenger restraint system is distinguishable for requiring a seat envelope to which various restraints are attached.

U.S. Pat. No. 5,074,588 issued on Dec. 24, 1991, to Fred Huspen describes a child safety restraint device for a vehicle seat comprising a rectangular back (stress) plate which is fastened to the seat back by the lap belt as well as a yoked belt with buckles passing under the child and to the stress plate. The device is distinguishable for requiring a stress plate.

U.S. Pat. No. 5,080,441 issued on Jan. 14, 1992, to Jennifer L. Stevenson et al. describes a safety seat for a child for airplane use comprising a lap bolster having a retractor system consisting of two tension straps connected to a male buckle adapter for pulling over the child's head and buckling between the legs. The safety seat is distinguishable for requiring a lap bolster.

U.S. Pat.No. 5,135,257 issued on Aug. 4, 1992, to Thomas T. Short describes an adjustable breakaway seat belt shoulder harness comfort strap device for attaching a strap with hook and loop fastening to the shoulder belt and a loop around the seat belt. The device is distinguishable for requiring a conventional seat and shoulder harness basis.

U.S. Pat. No. 5,429,418 issued on Jul. 4, 1995, to Carol A. Lipper et al. describes a child safety restraint system comprising a vehicular child restraint harness comprising a vest component including a head opening, a belt which buckles around the lower rib cage and a lower loop for passing the seat belt through. The harness is distinguishable for requiring an integrated vest element.

U.S. Pat. No. 5,536,066 issued on Jul. 16, 1996, to Mark A. Sedlack describes a harness for fixing a child restraint chair onto a school bus seat comprising a U-shaped harness with a crossing strap. The harness is distinguishable for its different structural configuration.

U.S. Pat. No. 6,123,388 issued on Sep. 2000, to Charles G. Vits et al. describes a restraint system for a school bus bench seat built into the frame of the bench seat. The restraint system is distinguishable for requiring the integrated construction with a bench seat frame.

U.S. Design Pat. No. 328,803 issued on Aug. 18, 1992, to Robert E. Franklin describes a vehicular child restraint harness comprising a waist strap with a buckle in front and a yoked strap attached to the rear of the waist strap and buckled in front to two short extensions on the waist strap. An extended strap at the rear of the waist strap is buckled apparently to the conventional female lap belt buckle. The harness is distinguishable for its unique structure.

U.S. Pat. No. 3,888,509 issued on Jun. 10, 1975, to Ronald A. Willey describes a bifurcated shoulder and lap continuous harness comprising a belt that is anchored on one side on the floor, traverses a floor guide and an overhead anchor to travel through another guide anchored on the opposite side on the floor, and traverses over the lap to be anchored on the one side on the floor. The harness is distinguishable for its configuration requiring various anchors and guides for a single elongated strap.

None of the above inventions and patents, taken either singly or in combination, is seen to describe the instant invention as claimed.

### SUMMARY OF THE INVENTION

The public is aware of not infrequent school bus accidents involving injury to the children being transported. This invention is an adjunct to existing seat belts on school buses to better protect the child from injury due to a sudden stop. An anchor strap element of the harness device is attached vertically around the seat back and secured by a buckle. The anchor strap has two outwardly extending shoulder straps which have intermediate automatic roll-type length adjusters having a protective sheet of lamb's wool attached by hook and loop fastening. The anchor strap also has two outwardly extending shorter straps with looped ends for threading the existing seat belt through them in order to maintain the position of the harness by not rotating on the seatback. The two shoulder straps have at the unattached ends a loop which enables the threading of the seat belt through the loop. The shorter extending straps are inside the other pair of shoulder straps for a small child, but positioned on the outside of the other pair for larger children. The four shoulder straps are already installed on the buckle side, and therefore would not readily slip off the seat belt. Thus, an add-on body harness is readily added to the bus seat for an improved condition of protection for the child.

Accordingly, it is a principal object of the invention to provide a retrofitting safety harness for children riding a school bus.

It is another object of the invention to provide a retro-fitting safety harness utilized in conjunction with existing lap belts with an anchor strap positioned vertically on the seat back.

It is a further object of the invention to provide a safety harness which has two pairs of straps extending from the vertical strap and easily utilized by a child in a school bus.

Still another object of the invention is to provide a safety harness which would better protect a child riding a school bus in the event of a vehicular accident.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a front elevational view of a child (in shadow) sitting in a school bus seat with the add-on harness according to the present invention.

FIG. 2 is a top plan view of an add-on safety harness according to the present invention.

FIG. 3 is an environmental front perspective view of an add-on safety harness according to the present invention on a bus seat.

FIG. 4 is an environmental rear perspective view of the add-on safety harness according to the present invention on a bus seat.

Similar reference characters denote corresponding features consistently throughout the attached drawings.

### DETAILED DESCRIPTION OF THE PREFERRED EMBODIMENT

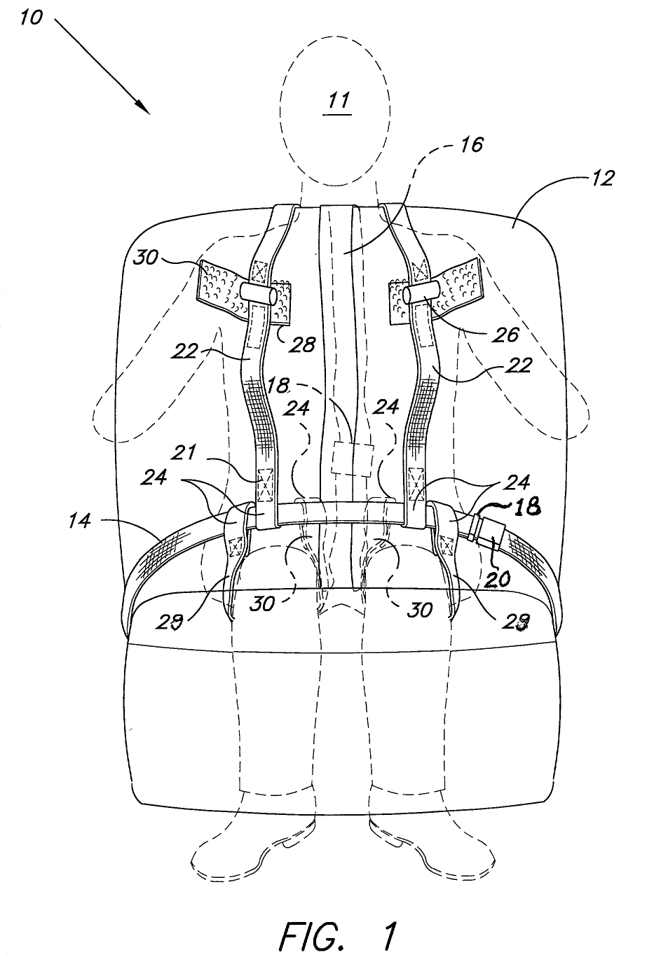

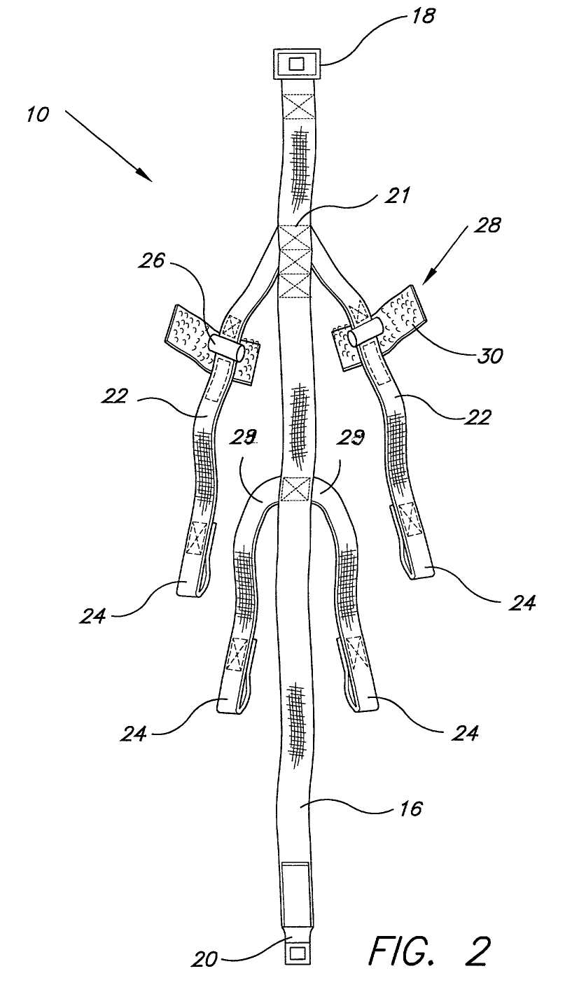

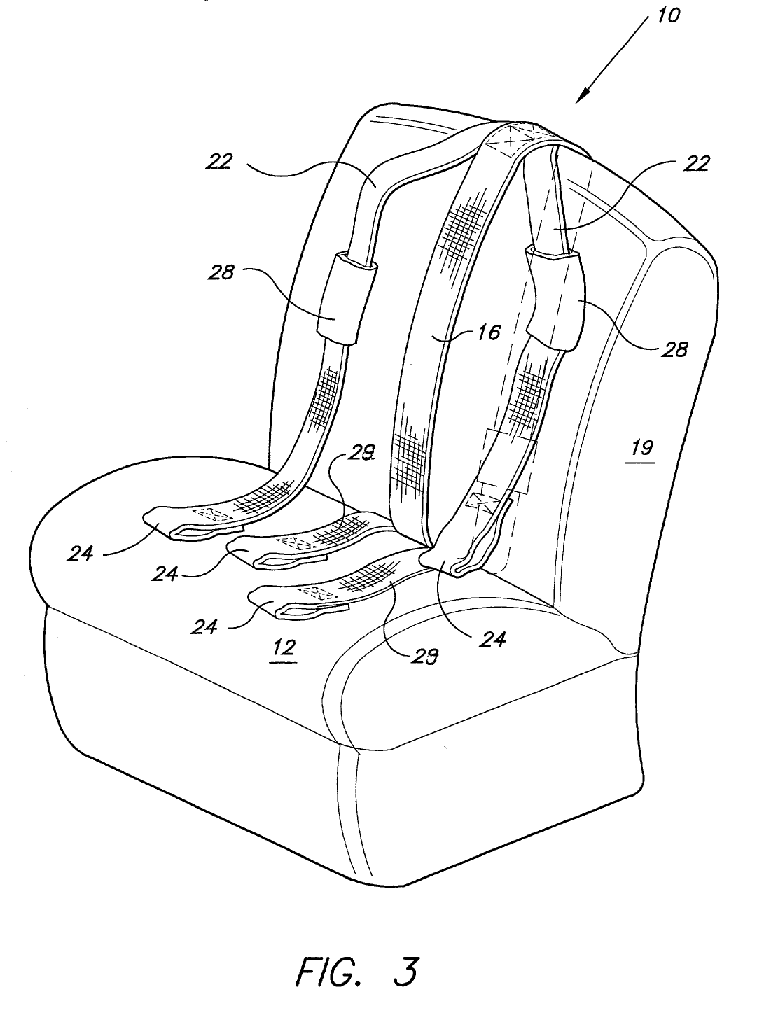

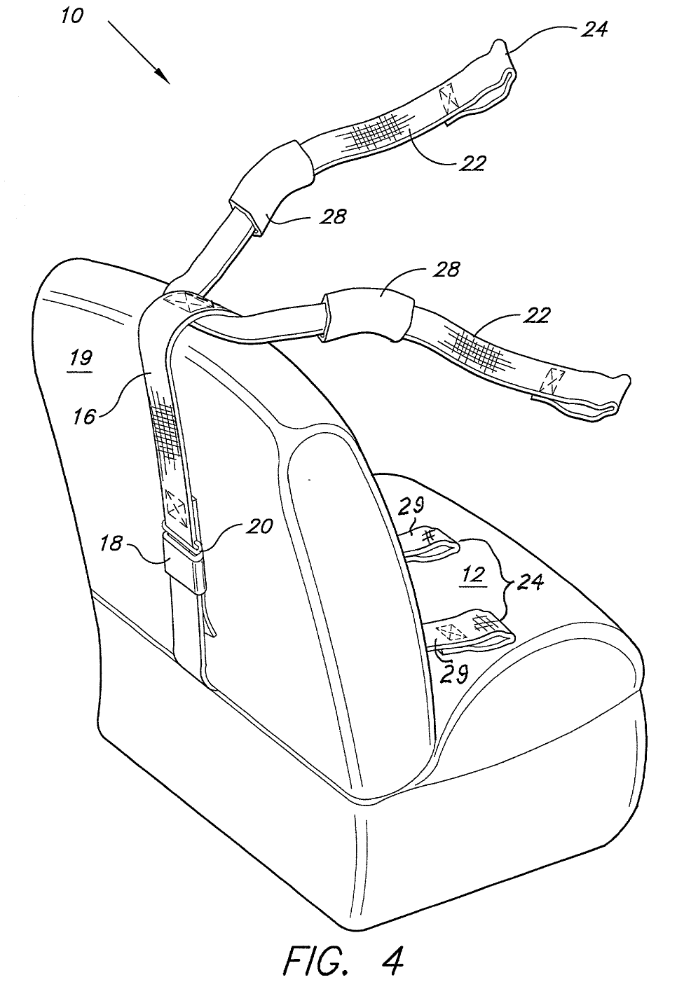

The present invention is illustrated in FIG. 1 as an add-on safety harness 10 on a child passenger 11 (shown in shadow) sitting in a school bus seat 12 having a lap belt 14. The harness 10, as shown in FIG. 2, comprises an elongated two inch wide main seat anchor strap 16 having a female snap-on buckle 18 on one end and a male buckle tongue 20 the opposite end so that the anchor strap 16 can be secured vertically around the seat back 19 as depicted in FIGS. 1, 3 and 4. Stitching 21 on the harness 10 is depicted as crosses. A pair of one inch wide shoulder harness straps 22 have their proximate ends extending from each side of the anchor strap 16 at an acute angle toward the buckle tongue 20. Each shoulder harness strap 22 has its distal end ending in a two inch wide loop 24. Another pair of one inch wide but shorter in length leg harness straps 29 are positioned further down with loops 24 at their ends. The leg harness straps 29 can be positioned in two different positions depending on the size of the child. In FIG. 1, the outside position depicted is for older children, while the dashed inside position is for smaller children. The leg harness straps 29 also prevent the anchor strap 16 from rotating on the seat back 19.

A metal roll-type adjuster device 26 having an adjustable adequate resistance to prevent looseness is positioned in a median location on each shoulder harness strap 22. A rectangular piece of synthetic lamb's wool 28 having hook and loop fastening 30 material attached thereto, as shown in FIGS. 1 and 2, is attached to each roll-type adjuster device 26 for surrounding each adjuster device in order to soften the pressure of the device 26 against the child's 11 chest.

A child passenger 11 can thread one end of the conventional lap belt 14 through the loops 24 of the shoulder harness straps 22 and the loops of the leg harness straps 29, if not already set up, to secure the child passenger 11, as the pair of adjuster devices 26 automatically adjust the tension to press the harness 10 against the chest of the child passenger 11.

The harness straps 16, 22 and 29 can be made from conventional automotive webbing which is strong and flexible. The add-on safety harness 10 has the advantages of utilization with existing lap type seat belts 14, protection of children on school buses, easy installation, portability for moving from bus to bus or within a bus, requires no special tools to install and maintain, and can adjust to children from age 3 to the teens.

It is to be understood that the present invention is not limited to the sole embodiment described above, but encompasses any and all embodiments within the scope of the following claims.

I claim:

1. An add-on safety harness for a school bus seat having a lap belt comprising:
an elongated main seat anchor strap having a snap-on buckle on one end and a buckle tongue on an opposite end; and
a pair of shoulder harness straps extending to opposite sides of said anchor strap at an acute angle, each said shoulder harness strap having a proximate end attached to said anchor strap and a distal end ending in a loop; and
length adjustment means for adjusting the length of each said shoulder strap;
whereby a child passenger can thread one end of a conventional lap belt through said loops of the shoulder harness straps to secure the child passenger as the pair of adjuster devices automatically adjust the tension to press the harness against the chest of the child passenger.

2. The add-on safety harness according to claim 1, wherein said length adjustment means comprises a metal roll-type adjuster disposed medially on each shoulder strap.

3. The add-on safety harness according to claim 2, further including a strip of synthetic lamb's wool having hook and loop fastening material attached to each said roll-type adjuster for surrounding each said adjuster device.

4. The add-on safety harness according to claim 1, further including a second pair of leg harness straps extending to opposite sides of said anchor strap at an acute angle, each said leg harness strap having a proximate end attached to said anchor strap and a distal end ending in a loop, and said loops positioned outside a large child's legs on the main seat anchor strap.

5. The add-on safety harness according to claim 1, further including a second pair of leg harness straps extending to opposite sides of said anchor strap at an acute angle, each said leg harness strap having a proximate end attached to said anchor strap and a distal end ending in a loop, and said loops positioned inside a small child's legs on the main seat anchor strap.
